(19) United States
(12) Patent Application Publication
(10) Pub. No.: US 2022/0190696 A1
(43) Pub. Date: Jun. 16, 2022

(54) System and Method for Manufacturing Stator Assembly

(71) Applicants: Hyundai Motor Company, Seoul (KR); Kia Corporation, Seoul (KR)

(72) Inventor: Seungkyu Jang, Suwon-si (KR)

(21) Appl. No.: 17/358,513

(22) Filed: Jun. 25, 2021

(30) Foreign Application Priority Data
Dec. 10, 2020 (KR) 10-2020-0172011

(51) Int. Cl. H02K 15/06; H02K 15/10; H02K 15/12; H02K 15/00; H02K 15/04

(52) U.S. Cl. CPC H02K 15/064; H02K 15/10; H02K 15/0421; H02K 15/0068; H02K 15/12

(57) ABSTRACT

A system for manufacturing a stator assembly having a stator core that includes slots and coils inserted into the slots includes a core loader, an insulation sheet inserter at a rear of the core loader to insert an insulation sheet into the slots, a coil former at a rear of the insulation sheet inserter to form the coils by bending, a preliminary aligner along the coil former to align the coils into a dummy core, a coil inserter at a rear of the insulation sheet inserter and connected to the preliminary aligner to insert the coils into the slots of the stator core, a coil winder at a rear of the coil inserter to twist end portions of the coils inserted into the stator core, and a varnish impregnator at a rear of the coil winder to impregnate varnish into the slots.

### CROSS-REFERENCE TO RELATED APPLICATIONS

This application claims the benefit of Korean Patent Application No. 10-2020-0172011, filed on Dec. 10, 2020, which application is hereby incorporated herein by reference.

### TECHNICAL FIELD

The present disclosure relates to a system and method for manufacturing a stator assembly.

### BACKGROUND

In line with the enforcement of global heating gas reduction regulations and international demand for the enhancement of fuel efficiency of vehicles, R&D and commercialization of environment-friendly vehicles and related component parts are actively in progress in the automotive industry.

As a kind of environment-friendly vehicle, a technology that uses an electric motor to exert a driving torque is being developed, and in particular, this requires technology for manufacturing a motor as well as for improving efficiency of the motor.

In order to reduce the weight and secure interior space of an environment-friendly vehicle, automakers and component part manufacturers are attempting to use hairpin coils in a drive motor.

A drive motor applied with hairpin coils may be advantageous in efficiency and output density by increasing the occupancy rate of the drive motor, but manufacturing and quality control are very difficult.

According to existing methods for manufacturing a drive motor applied with hairpin coils, unlike a traditional motor wound with coils, coils or wires with a generally rectangular cross-section are prepared as hairpin coils that are molded or formed in a generally U or V shape, such that they may be inserted into slots of the stator core.

Typically, the hairpin coils are inserted into slots of the stator core in an axial direction of the motor.

The ends of the hairpin coils protruding out of the slots of the stator core are twisted to physically contact one another.

The hairpin coils may be inserted into the slots as a plurality of layers.

For example, a plurality of hairpin coils may be paired, and two hairpin coils in a pair may be interconnected by welding ends.

Conventionally, various processes to manufacture a stator core assembly with such hairpin coils are typically processed separately, thus an overall cycle time is long, which become disadvantageous in terms of productivity and production cost.

The above information disclosed in this Background section is only for enhancement of understanding of the background of the invention, and therefore it may contain information that does not form the prior art that is already known to a person of ordinary skill in the art.

### SUMMARY

A system for manufacturing a stator assembly having a stator core formed with a plurality of slots along a circumference and a plurality of coils inserted into the slots is provided, where the system includes a core loading unit configured to load the stator core, an insulation sheet inserting unit disposed at a rear of the core loading unit and configured to insert an insulation sheet into the slots, a coil forming unit disposed at a rear of the insulation sheet inserting unit, and configured to form the coils by bending, a preliminarily aligning unit disposed along the coil forming unit and configured to preliminarily align the coils formed by bending into a dummy core, a coil inserting unit disposed at a rear of the insulation sheet inserting unit, connected to the preliminarily aligning unit, and configured to insert the coils aligned in the dummy core into the slots of the stator core, a coil winding unit disposed at a rear of the coil inserting unit, and configured to twist end portions of the coils inserted into the stator core to stably hold the coils, and a varnish impregnation unit disposed at a rear of the coil winding unit, and configured to impregnate varnish into the slots.

The coil forming unit may include a plurality of coil forming devices disposed by a predetermined spacing, and configured to form the coils of segment type by bending a supplied coil material in multiple stages.

The preliminarily aligning unit may be configured to preliminarily align the coils in the dummy core while the dummy core is repeatedly transferred rearward and forward through a plurality of conveyors that are vertically layered.

The preliminarily aligning unit may include a plurality of aligning devices configured corresponding to the coil forming devices and configured to be supplied with the coil formed by bending and preliminarily align the supplied coil in the dummy core, and a conveyor transfer apparatus configured to position the dummy core to an alignment position corresponding to the aligning device.

The conveyor transfer apparatus may include a first conveyor that is disposed lower than the aligning device, operates rearward, and may include a first lift disposed at a position corresponding to each of the aligning devices and configured to vertically operate and configured to move upward to load the dummy core on the alignment position when a pallet seated with the dummy core arrives at the first lift, a second conveyor that is disposed lower than the first conveyor, operates in a direction opposite to the first conveyor to return the dummy core into which the coils are inserted to the coil inserting unit, and may include a second lift that is disposed lower than the first lift and configured to vertical operate together with the first lift, a third lift disposed lower than the second lift, and configured to vertically operate together with the first lift and the second lift, and a lift master connected to rear ends of the first conveyor and the second conveyor, and configured to lower the pallet transferred from the first conveyor to the second conveyor.

The first lift, the second lift, and the third lift may be disposed at a same horizontal position, and configured to be simultaneously operated by a cylinder.

The first lift may be configured to dispose the dummy core seated on the pallet to the alignment position when lifted by the cylinder. The second lift may be configured to be in line with the first conveyor when lifted by the cylinder. The third lift may be configured to be in line with the second conveyor when lifted by the cylinder.

The coil winding unit may include a twisting device configured to twist certain regions of leg portions extruding to an outside of the slots of the stator core in order to perform a welding process to interconnect the coils through the welding portions formed at the leg portions of the coils, a cutting device configured to uniformly cut the end portions of the leg portions, and at least one welding device configured to weld the welding portions of adjacent coils.

The at least one welding device may include a laser welding device configured to weld the welding portions of adjacent coils by laser welding, and a terminal welding device configured to weld a connection terminal to head portions of the coils to allow electrical conductivity.

The varnish impregnation unit may include an epoxy coating device configured to coat epoxy on leg portions of the coils, and a varnish impregnating device configured to impregnate varnish into an interior of the slots.

The system may further include an inspection unit disposed at a rear of the varnish impregnation unit, and configured to inspect a quality of the stator assembly through electrical inspection.

According to a system and method for manufacturing a stator assembly according to an exemplary embodiment, entire processes of forming of the coils, insertion of the coils into the stator core, and fixing of the coils in the slots may be in-lined, by which productivity and investment cost may be improved.

In addition, according to a system and method for manufacturing a stator assembly, the conveyor transfer apparatus may be operated without an interruption, thereby increasing manufacturing speed while securing product quality.

Other effects that may be obtained or are predicted by exemplary embodiments will be explicitly or implicitly described in a detailed description of embodiments of the present invention. That is, various effects that are predicted according to exemplary embodiments will be described in the following detailed description.

### BRIEF DESCRIPTION OF THE DRAWINGS

FIG. 1 is a schematic diagram of a stator assembly manufactured by a system and method for manufacturing a stator assembly according to an exemplary embodiment.

FIG. 2 is a schematic diagram of a system for manufacturing a stator assembly according to an exemplary embodiment.

FIG. 3 and FIG. 4 are schematic diagrams of a coil forming unit and a preliminarily aligning unit applied to a system for manufacturing a stator assembly according to an exemplary embodiment.

FIG. 5 is a flowchart showing a method for manufacturing a stator assembly according to an exemplary embodiment.

The following elements may be used in connection with the drawings to describe embodiments of the present invention.

| | |
|---|---|
| 1: stator assembly | 3: stator core |
| 5: slot | 7: insulation sheet |
| 10: coil | 11: head portion |
| 13: leg portion | 15: welding portion |
| 20: dummy core | 100: manufacturing system |
| 110: core loading unit | 120: insulation sheet inserting unit |
| 130: coil forming unit | 131: coil forming device |
| 140: preliminarily aligning unit | 1.41: aligning device |
| 143: pusher | S: alignment position |
| 145: pallet | 150: conveyor transfer apparatus |
| 151: first conveyor | 153: first lift |
| 155: second conveyor | 157: second lift |
| 159: third lift | 160: lift master |
| 161: cylinder | 170: coil inserting unit |
| 171: gripper | 180: coil winding unit |
| 181: twisting device | 183: cutting device |
| 185: welding device | 187: laser welding device |
| 189: terminal welding device | 190: varnish impregnation unit |
| 191: epoxy coating device | 193: varnish impregnating device |
| 200: inspection unit | |

### DETAILED DESCRIPTION OF ILLUSTRATIVE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In order to clarify embodiments of the present invention, parts that are not related to the description will be omitted, and the same elements or equivalents are referred to with the same reference numerals throughout the specification.

In the following description, dividing names of components into first, second, and the like is to divide the names because the names of the components are the same as each other, and an order thereof is not particularly limited.

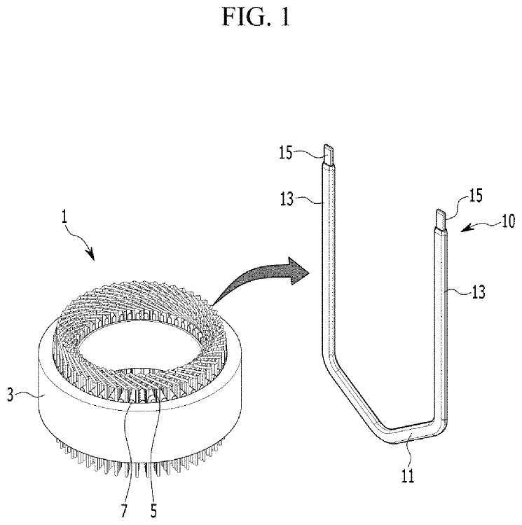

FIG. 1 is a schematic diagram of a stator assembly 1 manufactured by a system and method for manufacturing a stator assembly according to an exemplary embodiment.

Referring to FIG. 1, a system and method for manufacturing a stator assembly according to an exemplary embodiment may be used to manufacture a stator assembly that includes a stator core 3 and coils 10 inserted into a plurality of slots 5 formed along a circumference of the stator core 3.

The stator core 3 is formed in a shape of a generally circular tube.

A rotor (not shown) may be disposed inside the stator core 3, and the rotor may be configured to be rotatable around a rotation shaft.

In the stator core 3, the slots 5 may be formed along the circumference of the stator core 3.

The slots 5 may be formed in a multi-layered structure.

In other words, a plurality of layers may be formed in each slot 5, in a radial direction of the stator core 3.

For example, four layers may be formed in each slot 5.

However, the number of layers formed in the slot 5 may be appropriately set depending on the motor output and winding design.

The coils 10 are inserted into respective layers of the slots 5 described above.

The coil 10 is U-shaped or V-shaped, and is also referred to as “hairpin coil” in the industry.

The coil 10 may be formed in a segment type, for example, as a flat type having a rectangular cross-section.

While being inserted into the slots 5 of the stator core 3, adjacent coils 10 are interconnected to form a coil winding section.

Each coil 10 includes a head portion 11 and leg portions 13 formed at both sides of the head portion 11.

The leg portions 13 are inserted into corresponding slots 5 of the stator core 3.

In addition, while being inserted into the slots 5 of the stator core 3, the leg portion 13 partially extrudes from the slots 5 of the stator core 3.

A predetermined end portion of the leg portion 13 is formed as a welding portion 15.

At this time, the welding portion 15 may be formed by peeling off a certain area of the end portion of the leg portion 13.

When the coil 10 is inserted into the slot 5 of the stator core 3, the extruding portion of the leg portion 13 of each coil 10 outward from the stator core 3 is bent or twisted along a circumference direction of the stator core 3.

The specific direction or angle at which the leg portion 13 of the coil 10 is bent may depend on details of winding design.

In addition, the leg portions 13 may be bent in a same direction or in opposite directions.

Such bent coils 10 are welded to one another by the welding portion 15, to form electrical connection between the coils 10.

When the coil 10 is inserted into the stator core 3, the coils 10 may be fixed and protected by impregnating varnish to an interior of the stator core 3.

A system and method for manufacturing a stator assembly according to an exemplary embodiment may be applied to manufacture the stator assembly 1, by forming the coils 10, preliminarily aligning the formed coils 10, inserting the coils 10 into the stator core 3, and fixing the coils 10 in the stator core 3 by the varnish impregnation.

For such a purpose, a system 100 for manufacturing a stator assembly according to an exemplary embodiment may be configured as follows.

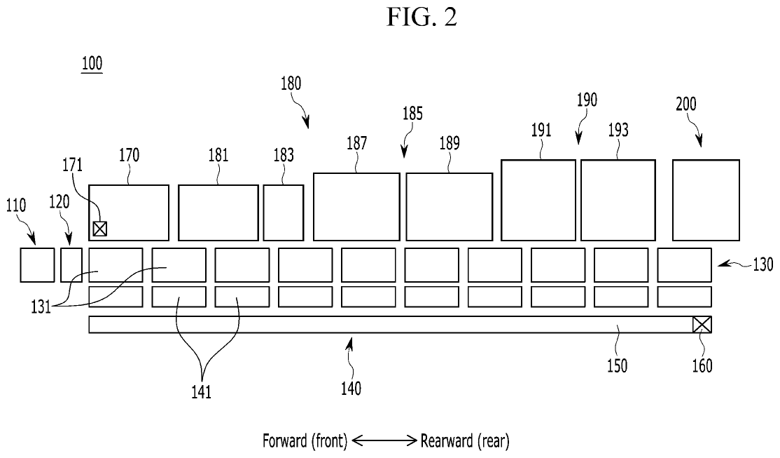

FIG. 2 is a schematic diagram of a system for manufacturing a stator assembly according to an exemplary embodiment.

FIG. 2 is generally a plan view of the system 100 for manufacturing a stator assembly. However, this does not strictly limit that every element shown in FIG. 2 is horizontally arranged, and it may be understood that, if not described to the contrary, some elements may be vertically over another element.

Referring to FIG. 2, a system 100 for manufacturing a stator assembly according to an exemplary embodiment includes a core loading unit 110, an insulation sheet inserting unit 120, a coil forming unit 130, a preliminarily aligning unit 140, a coil inserting unit 170, a coil winding unit 180, a varnish impregnation unit 190, and an inspection unit 200.

The core loading unit 110 is configured to load the stator core 3.

The core loading unit 110 may be configured to store a plurality of stator cores 3 and supply each stator core 3. Different core loading units 110 may be provided to support different stator cores 3.

The insulation sheet inserting unit 120 is disposed at a rear of the core loading unit 110.

In an exemplary embodiment, reference directions are made with reference to FIG. 2.

Hereinafter, a direction toward the core loading unit 110 is called front or forward and a direction toward the coil forming unit 130 is called rear or rearward. Terms such as an upper portion, an upper end, an upper surface, and an upper end portion are used to indicate a part disposed in an upper side, and terms such as a lower portion, a lower end, a lower surface, and a lower end portion are used to indicate a part disposed in a lower side.

In addition, hereinafter, an “end (one end, another end, and the like)” may be defined as any one end or may be defined as a portion (one end portion, another end portion, and the like) including that end.

The insulation sheet inserting unit 120 is configured to insert an insulation sheet 7 into the slots 5.

The insulation sheet inserting unit 120 is configured to insert the insulation sheet 7 into the slots 5 of the stator core 3 when the stator core 3 is transferred from the core loading unit 110.

The insulation sheet 7 is stored separately.

The coil forming unit 130 is disposed at a rear of the insulation sheet inserting unit 120.

The coil forming unit 130 includes a plurality of coil forming devices 131, and is configured to form the coil 10 by bending.

The coil forming devices 131 may be disposed by a predetermined spacing.

The coil forming devices 131 may be configured to form the segment type coils 10 by bending a supplied coil material in multiple stages.

The coil forming devices 131 may form the coils 10 by bending in multiple stages to a generally U-shaped or V-shaped form.

The preliminarily aligning unit 140 is disposed along the coil forming unit 130.

That is, the coil forming unit 130 and the preliminarily aligning unit 140 may be disposed in parallel, as shown in FIG. 2.

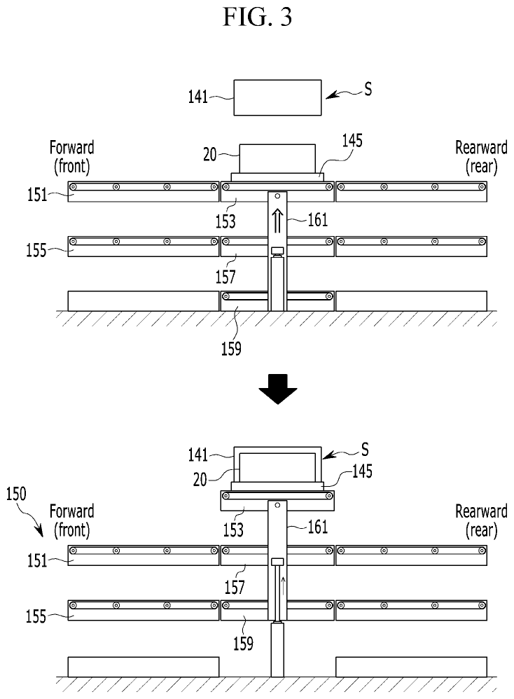

The preliminarily aligning unit 140 is configured to preliminarily align the coils 10 formed by bending in a dummy core 20 (refer to FIG. 3) while the dummy core 20 is being transferred by a conveyor transfer apparatus 150.

That is, the preliminarily aligning unit 140 is configured to preliminarily align the coils 10 into the dummy core 20, while the dummy core 20 is repeatedly transferred rearward and forward through a plurality of conveyors that are vertically layered.

The coil inserting unit 170 is disposed at a rear of the insulation sheet inserting unit 120, connected to the preliminarily aligning unit 140, and configured to insert the coils 10 aligned in the dummy core 20 into the slots 5 of the stator core 3.

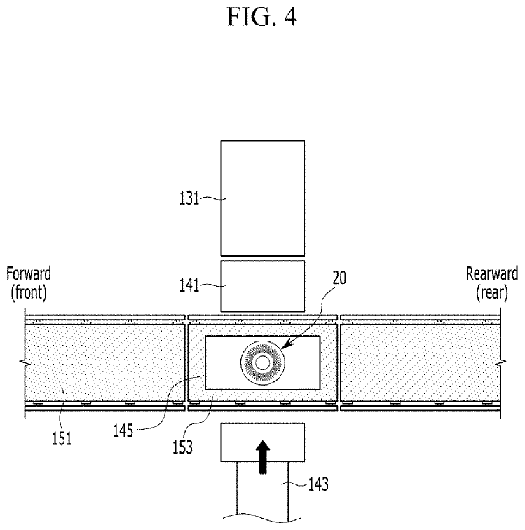

FIG. 3 and FIG. 4 are schematic diagrams of the coil forming unit 130 and the preliminarily aligning unit 140 applied to a system for manufacturing a stator assembly according to an exemplary embodiment.

FIG. 3 is a lateral view of the system 100 for manufacturing a stator assembly, and FIG. 4 is a plan view of the system 100 for manufacturing a stator assembly.

Referring to FIG. 3 and FIG. 4, the preliminarily aligning unit 140 includes a plurality of aligning devices 141 and the conveyor transfer apparatus 150.

The aligning devices 141 are configured corresponding to the coil forming devices 131.

That is, the aligning devices 141 may be configured in the same quantity with the coil forming devices 131.

Each aligning device 141 is configured between a corresponding coil forming device 131 and the conveyor transfer apparatus 150, and is configured to be supplied with the coil 10 formed by bending and preliminarily align the supplied coil in the dummy core 20.

For such a purpose, the aligning devices 141 and the coil forming devices 131 are arranged in parallel to match each other, and the conveyor transfer apparatus 150 is also disposed in parallel with the pairs of the coil forming devices 131 and the aligning devices 141.

The aligning device 141 is disposed between the coil forming device 131 and the conveyor transfer apparatus 150, the dummy core 20 transferred from the conveyor transfer apparatus 150 is moved to the aligning device 141 by a pusher 143, and the coils 10 formed at the coil forming device 131 are preliminarily aligned into the dummy core 20 by the aligning device 141.

For such a purpose, the conveyor transfer apparatus 150 is configured to position the dummy core 20 to an alignment position S corresponding to the aligning device 141, such that the coils 10 may be easily inserted into the dummy core 20.

The conveyor transfer apparatus 150 may include a total of three layers.

The conveyor transfer apparatus 150 includes a first layer of a first conveyor 151, a second layer of a second conveyor 155, and a third layer of a third lift 159.

The first conveyor 151 is disposed lower than the aligning device 141.

The first conveyor 151 operates from the front (corresponding to the insulation sheet inserting unit 120) to the rear.

At this time, the first conveyor 151 is disposed at positions corresponding to the plurality of aligning devices 141 and configured to vertically operate and configured to vertically move.

A pallet 145 seated with the dummy core 20 moves rearward from the front corresponding to the insulation sheet inserting unit 120, and the first lift 153 is configured to, when the pallet 145 arrives at the first lift 153, move upward to load the dummy core 20 on the alignment position S of the aligning device 141.

In addition, the second conveyor 155 is disposed lower than, e.g., below, the first conveyor 151.

The second conveyor 155 operates in a direction opposite to the first conveyor 151.

That is, the second conveyor 155 operates in a direction opposite to the first conveyor 151 to return the dummy core 20 into which the coils 10 are inserted to the coil inserting unit 170.

In addition, the second conveyor 155 includes a plurality of second lifts 157 disposed lower than the first lifts 153 and configured to vertical operate together with the first lifts 153;

The second lift 157 may become in line with the first conveyor 151 when lifted together with the first lift 153 by the cylinder 161.

A lift master 160 is connected to rear ends of the first conveyor 151 and the second conveyor 155.

The lift master 160 is configured to lower the pallet 145 transferred from the first conveyor 151 to the second conveyor 155.

A third lift 159 is disposed lower than each second lift 157, and is configured to vertically operate together with the first lift 153 and the second lift 157.

The first lift 153, the second lift 157, and the third lift 159 are disposed at a same horizontal position, and are configured to simultaneously move in the vertical direction by the cylinder 161.

In addition, the first lift 153, the second lift 157, and the third lift 159 are provided corresponding to each pair of the coil forming device 131 and the aligning device 141.

The first lift 153 is configured to dispose the dummy core 20 seated on the pallet 145 to the alignment position S when lifted by the cylinder 161.

The second lift 157 is configured to be in line with the first conveyor 151 when lifted by the cylinder 161.

The third lift 159 is configured to be in line with the second conveyor 155 when lifted by the cylinder 161.

By the above operation, the first conveyor 151 and the second conveyor 155 may be operated continuously without stopping.

In more detail, when the dummy core 20 loaded on the pallet 145 arrives at the coil forming device 131 and the aligning device 141 that are firstly positioned in the system 100, corresponding first, second, and third lifts 153, 157, and 159 are operated to move upward, and the coils 10 are preliminarily aligned in the dummy core 20 at the alignment position S.

At this time, the second lift 157 becomes in line with the first conveyor 151, and the third lift 159 becomes in line with the second conveyor 155. Therefore, another pallet 145 may continuously move to the coil forming device 131 and the aligning device 141 that are subsequent, next subsequent, and so on, by the first conveyor 151.

When the dummy core 20 where the coils 10 are preliminarily aligned returns to the first lift 153, the first, second, and third lifts 153, 157, and 159 are operated to move downward, and thus, the dummy core 20 with the preliminarily aligned coils 10 may be transferred rearward by the first conveyor 151. Then, the dummy core 20 with the preliminarily aligned coils 10 may be transferred to the second conveyor 155 by the lift master 160, and then is moved forward, toward the coil inserting unit 170, by the second conveyor 155.

Referring back to FIG. 2, when the dummy core 20 with the preliminarily aligned coils 10 is transferred to the coil inserting unit 170, the coil inserting unit 170 connected to the preliminarily aligning unit 140 may insert the coils 10 preliminarily aligned in the dummy core 20, into the slots 5 of the stator core 3.

The coil inserting unit 170 uses a gripper 171 to clamp the preliminarily aligned coils 10 in the dummy core 20 at once, and inserts the aligned coils 10 into the slots 5 of the stator core 3.

The coil winding unit 180 is disposed at a rear of the coil inserting unit 170.

The coil winding unit 180 twists end portions of the coils 10 inserted into the stator core 3 so as to stably hold the coils 10 in the stator core 3.

The coil winding unit 180 includes a twisting device 181, a cutting device 183, and at least one welding device 185.

The twisting device 181 twists certain regions of the leg portions 13 in order to perform a welding process to interconnect the coils 10 through the welding portions 15 formed at the leg portions 13 of the coils 10, which extrude to the outside of the slots 5 of the stator core 3.

In addition, the cutting device 183 is configured to uniformly cut the end portions of the leg portions 13.

In addition, the at least one welding device 185 is configured to weld the welding portions 15 of adjacent coils 10, and may include a laser welding device 187 and a terminal welding device 189.

The laser welding device 187 is configured to weld the welding portions 15 of adjacent coils 10 by laser welding.

The terminal welding device 189 is configured to weld a connection terminal to the head portions 11 of the coils 10 to allow electrical conductivity.

The varnish impregnation unit 190 is disposed at a rear of the coil winding unit 180.

The varnish impregnation unit 190 includes an epoxy coating device 191 and a varnish impregnating device 193, in order to impregnate varnish into the slots 5.

The epoxy coating device 191 is configured to coat epoxy on the leg portions 13 of the coils 10.

In addition, the varnish impregnating device 193 is configured to impregnate the varnish into the interior of the slots 5, by which the stator assembly 1 may be completed.

Finally, the inspection unit 200 is disposed at a rear of the varnish impregnation unit 190.

The inspection unit 200 is configured to inspect a quality of the stator assembly 1 through electrical inspection.

An exemplary method for manufacturing the stator assembly 1 according to an embodiment is hereinafter described in detail.

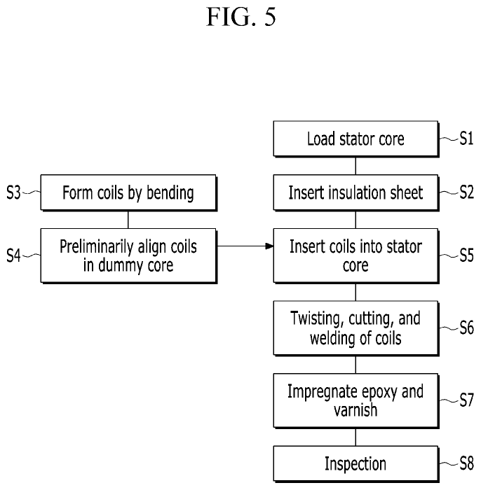

FIG. 5 is a flowchart showing a method for manufacturing a stator assembly according to an exemplary embodiment.

Referring to FIG. 5, in a method for manufacturing a stator assembly according to an exemplary embodiment, the stator core 3 is loaded on the core loading unit 110 at step S1.

Different core loading units 110 may be provided to support different stator cores 3.

Then, the stator core 3 is transferred from the core loading unit 110 to the insulation sheet inserting unit 120.

Subsequently at step S2, the insulation sheet 7 is inserted into the slot 5 by the insulation sheet inserting unit 120.

Then, at step S3, the coils 10 are formed by bending by the coil forming unit 130.

At this time, a plurality of coils 10 in a segment type are simultaneously formed by bending a coil material in multiple stages by a plurality of the coil forming devices 131.

The coil 10 may be formed in a generally U-shaped or V-shaped form.

The coil forming devices 131 are disposed by a predetermined spacing along the conveyor transfer apparatus 150.

In addition, at step S4, the dummy core 20 is supplied by the conveyor transfer apparatus 150.

The coils 10 bent in multiple stages are preliminarily aligned in the dummy core 20.

For such a purpose, first, the pallet 145 seated with the dummy core 20 is transferred rearward, i.e., in a direction farther from the insulation sheet inserting unit 120, by the first conveyor 151.

When the pallet 145 arrives at the first lift 153, the first lift 153 is operated to move upward, and thereby the dummy core 20 is loaded to the alignment position S.

When the dummy core 20 is loaded on the alignment position S, the dummy core 20 is moved toward the aligning device 141 by the pusher 143, and the coils 10 are preliminarily aligned in the dummy core 20.

When the preliminary alignment of the coils 10 is finished, the dummy core 20 is returned to the first lift 153, and the first lift 153 moves downward to be in line with the first conveyor 151.

Then, the first lift 153 may move rearward to the lift master 160 by the first conveyor 151, and then may be transferred to the second conveyor 155 by the lift master 160.

In addition, the dummy core 20 with the preliminarily aligned coils 10 is transferred toward the coil inserting unit 170 by the second conveyor 155.

At this time, when the first lift 153 is moved upward and downward, the second lift 157 below the first lift 153 and the third lift 159 below the second lift 157 simultaneously move upward and downward, together with the first lift 153.

Thus, when the first lift 153 is moved upward, the second lift 157 becomes in line with the first conveyor 151, and the third lift 159 becomes in line with the second conveyor 155, such that the first and second conveyors 151 and 155 may be continuously operated without an interruption.

Accordingly, the coils 10 are preliminarily aligned in the dummy core 20 while the dummy core 20 is moved rearward by the conveyor transfer apparatus, and then the dummy core 20 is transferred forward to the coil inserting unit 170.

It may be understood that a plurality of dummy cores 20 may be used such that while one dummy core 20 is being filled with the coils 10, another dummy core 20 may be transferred to be filled with the coils 10, and still another dummy core 20 filled with the coils 10 may be transferred toward the coil inserting unit 170.

At step S5, the coils 10 preliminarily aligned in the dummy core 20 are inserted into the stator core 3 by the coil inserting unit 170.

At the step S5, the coil inserting unit 170 uses the gripper 171 to clamp the preliminarily aligned coils 10 in the dummy core 20 at once, and inserts the aligned coils 10 into the slots 5 of the stator core 3.

At this time, the stator core 3 is transferred from the coil inserting unit 170 to the coil winding unit 180.

At step S6, the coils 10 inserted into the stator core 3 are twisted by the coil winding unit 180 so as to stably hold the coils 10 in the stator core 3.

For such a purpose, the stator core 3 installed with the coils 10 is transferred to the twisting device 181, and certain regions of the leg portions 13 of the coils 10 extruding to an outside of the slots 5 of the stator core 3 are twisted by the twisting device 181.

In addition, the end portions of the leg portions 13 may be uniformly cut by the cutting device 183.

Then the leg portions of adjacent coils 10 extruding to the outside of the slots 5 are welded by the laser welding device 187.

Subsequently, a connection terminal is welded to the head portions 11 of the coils 10 by a terminal welding device 189 to allow electrical conductivity.

Then, the stator core 3 is transferred from the coil winding unit 180 to the varnish impregnation unit 190.

At step S7, the varnish is impregnated into the interior of the slots 5 by the varnish impregnation unit 190 to fix the coils 10 in the slots 5.

At this time, epoxy may be coated on the leg portions 13 of the coils 10 by the epoxy coating device 191, and the varnish may be impregnated into the interior of the slots 5 by the varnish impregnating device 193 to fix the coils 10 in the slots 5.

Finally, at step S8, the stator assembly 1 finished with the varnish impregnation is inspected by the inspection unit 200.

That is, the electrical quality of the stator assembly 1 is inspected by the inspection unit 200 disposed at a rear of the varnish impregnation unit.

Therefore, according to a system and method for manufacturing a stator assembly according to an exemplary embodiment, entire processes of forming of the coils 10, insertion of the coils 10 into the stator core 3, and fixing of the coils 10 in the slots may be in-lined, by which productivity and investment cost may be improved.

In addition, according to a system and method for manufacturing a stator assembly, the conveyor transfer apparatus 150 may be operated without an interruption, thereby increasing manufacturing speed while securing product quality.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A system for manufacturing a stator assembly having a stator core that includes a plurality of slots along a circumference and a plurality of coils inserted into the slots, the system comprising:
a core loading unit configured to load the stator core;
an insulation sheet inserting unit disposed at a rear of the core loading unit and configured to insert an insulation sheet into the slots;
a coil forming unit disposed at a rear of the insulation sheet inserting unit and configured to form the coils by bending;
a preliminarily aligning unit disposed along the coil forming unit and configured to preliminarily align the coils formed by bending into a dummy core;
a coil inserting unit disposed at a rear of the insulation sheet inserting unit, connected to the preliminarily aligning unit, and configured to insert the coils aligned in the dummy core into the slots of the stator core;
a coil winding unit disposed at a rear of the coil inserting unit and configured to twist end portions of the coils inserted into the stator core to stably hold the coils; and
a varnish impregnation unit disposed at a rear of the coil winding unit and configured to impregnate varnish into the slots.

2. The system of claim 1, wherein the preliminarily aligning unit is configured to preliminarily align the coils in the dummy core while the dummy core is repeatedly transferred rearward and forward through a plurality of conveyors that are vertically layered.

3. The system of claim 1, wherein the coil winding unit comprises:
a twisting device configured to twist certain regions of leg portions of the coils extruding to an outside of the slots of the stator core to perform a welding process to interconnect the coils through welding portions formed at the leg portions of the coils;
a cutting device configured to uniformly cut the end portions of the leg portions; and
at least one welding device configured to weld the welding portions of adjacent coils.

4. The system of claim 3, wherein the at least one welding device comprises:
a laser welding device configured to weld the welding portions of adjacent coils by laser welding; and
a terminal welding device configured to weld a connection terminal to head portions of the coils to allow electrical conductivity.

5. The system of claim 1, wherein the varnish impregnation unit comprises:
an epoxy coating device configured to coat epoxy on leg portions of the coils; and
a varnish impregnating device configured to impregnate the varnish into an interior of the slots.

6. The system of claim 1, further comprising an inspection unit disposed at a rear of the varnish impregnation unit and configured to inspect a quality of the stator assembly through electrical inspection.

7. A system for manufacturing a stator assembly having a stator core including a plurality of slots along a circumference and a plurality of coils inserted into the slots, the system comprising:
a core loading unit configured to load the stator core;
an insulation sheet inserting unit disposed at a rear of the core loading unit and configured to insert an insulation sheet into the slots;
a coil forming unit disposed at a rear of the insulation sheet inserting unit and comprising a plurality of coil forming devices disposed by a predetermined spacing, wherein the coil forming unit is configured to form the coils of a segment type by bending a supplied coil material in multiple stages;
a preliminarily aligning unit disposed along the coil forming unit and configured to preliminarily align the coils formed by bending into a dummy core;
a coil inserting unit disposed at a rear of the insulation sheet inserting unit, connected to the preliminarily aligning unit, and configured to insert the coils aligned in the dummy core into the slots of the stator core;
a coil winding unit disposed at a rear of the coil inserting unit and configured to twist end portions of the coils inserted into the stator core to stably hold the coils; and
a varnish impregnation unit disposed at a rear of the coil winding unit and configured to impregnate varnish into the slots.

8. The system of claim 7, wherein the preliminarily aligning unit comprises:
a plurality of aligning devices configured to correspond to the coil forming devices and configured to be supplied with the coils formed by bending and preliminarily align the supplied coils in the dummy core; and
a conveyor transfer apparatus configured to position the dummy core to an alignment position corresponding to the aligning device.

9. The system of claim 8, wherein the conveyor transfer apparatus comprises:
a first conveyor that is disposed lower than the aligning device, is configured to operate rearward, and includes a first lift disposed at a position corresponding to each of the aligning devices, wherein the first lift is configured to vertically operate and to move upward to load the dummy core on the alignment position when a pallet seated with the dummy core arrives at the first lift;
a second conveyor that is disposed lower than the first conveyor, is configured to operate in a direction opposite to the first conveyor to return the dummy core into which the coils are inserted to the coil inserting unit, and includes a second lift that is disposed lower than the first lift and is configured to vertically operate together with the first lift;
a third lift disposed lower than the second lift and configured to vertically operate together with the first lift and the second lift; and
a lift master connected to rear ends of the first conveyor and the second conveyor, wherein the lift master is configured to lower the pallet transferred from the first conveyor to the second conveyor.

10. The system of claim 9, wherein the first lift, the second lift, and the third lift are disposed at a same horizontal position and are configured to be simultaneously operated by a cylinder.

11. The system of claim 10, wherein:
the first lift is configured to dispose the dummy core seated on the pallet to the alignment position when lifted by the cylinder;
the second lift is configured to be in line with the first conveyor when lifted by the cylinder; and
the third lift is configured to be in line with the second conveyor when lifted by the cylinder.

12. A method for manufacturing a stator assembly having a stator core including a plurality of slots along a circumference and a plurality of coils inserted into the slots, the method comprising:
loading the stator core on a core loading unit;
inserting an insulation sheet into the slots by an insulation sheet inserting unit;
forming the coils by bending by a coil forming unit;
supplying a dummy core by a conveyor transfer apparatus and preliminarily aligning the coils in the dummy core;
inserting the preliminarily aligned coils in the dummy core into the stator core by a coil inserting unit;
twisting the coils inserted into the stator core by a coil winding unit to stably hold the coils in the stator core; and
impregnating varnish into the slots by a varnish impregnation unit to fix the coils.

13. The method of claim 12, wherein forming the coils by bending comprises simultaneously forming a plurality of coils in a segment type by bending a coil material in multiple stages by a plurality of coil forming devices.

14. The method of claim 12, wherein supplying the dummy core and preliminarily aligning the coils in the dummy core comprises:
transferring a pallet seated with the dummy core in a direction away from the insulation sheet inserting unit by a first conveyor of the conveyor transfer apparatus;
operating a first lift to move upward such that the dummy core is loaded on an alignment position after the pallet arrives at the first lift;
preliminarily aligning the coils in the dummy core after the dummy core is loaded on the alignment position;
operating the first lift to move downward after preliminarily aligning the coils is complete, wherein the dummy core with the preliminarily aligned coils moves along the first conveyor and is transferred to a second conveyor lower than the first conveyor; and
transferring the dummy core with the preliminarily aligned coils toward the coil inserting unit.

15. The method of claim 14, wherein, in supplying the dummy core and preliminarily aligning the coils in the dummy core, a second lift below the first lift, and a third lift below the second lift simultaneously move upward and downward together with the first lift, wherein the second lift is in line with the first conveyor and the third lift is in line with the second conveyor when operating the first lift to move upward is completed.

16. The method of claim 14, wherein, in inserting the preliminarily aligned coils into the stator core, the coil inserting unit uses a gripper to clamp the preliminarily aligned coils at once and inserts the preliminarily aligned coils into the slots of the stator core.

17. The method of claim 12, wherein twisting the coils comprises:
twisting certain regions of leg portions of the coils extruding to an outside of the slots of the stator core by a twisting device;
uniformly cutting end portions of the leg portions by a cutting device;
welding the leg portions of adjacent coils by a laser welding device; and
welding a connection terminal to head portions of the coils by a terminal welding device to allow electrical conductivity.

18. The method of claim 12, wherein impregnating the varnish comprises:
coating epoxy on leg portions of the coils by an epoxy coating device;
impregnating the varnish into an interior of the slots by a varnish impregnating device to fix the coils in the slots; and
uniformly cutting end portions of the leg portions by a cutting device.

19. The method of claim 12, further comprising, after impregnating the varnish, inspecting an electrical quality of the stator assembly by an inspection unit disposed at a rear of the varnish impregnation unit.
